(19) United States
(12) Patent Application Publication
(10) Pub. No.: US 2006/0052116 A1
(43) Pub. Date: Mar. 9, 2006

(54) Cellular phone area code look-up tables

(75) Inventors: Kulvir Singh Bhogal, Fort Worth, TX (US); Kwang Sik Kang, Astoria, NY (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/937,690

(22) Filed: Sep. 9, 2004

(51) Int. Cl. H04Q 7/20

(52) U.S. Cl. 455/456.5; 455/456.1

(57) ABSTRACT

An improved caller ID system for providing geographic location information about an incoming call to a cell phone is provided. The area code of an incoming call based on the caller ID information is detected and an area code database is accessed within the cell phone or on the cellular network. The corresponding geographic location of the detected area code for the incoming call is retrieved from the database and displayed for the user on the cell phone, either automatically in response to the incoming call or upon actuation of the function by the user.

### TECHNICAL FIELD

The present invention is related in general to software and systems in a mobile wireless communication device, and in particular to determining the geographic location of an incoming telephone call to a cellular phone based on area code information.

### BACKGROUND

Communication devices, including telephones, cellular phones (cell phones), paging devices and the like have become an integral part of business and domestic environments. A variety of caller identification, call screening and call blocking devices and/or services are offered or have been contemplated. However, such devices and services merely display calling party telephone numbers or names. Often, such information does not fully identify the caller, particularly when the caller's name or phone number is not recognized. It would be desirable to permit the telephone user to query for more information about the caller. For example, while the area code of the caller is typically displayed in conventional caller identification (Caller ID) systems, the user may have no knowledge of the geographic location of the incoming call's area code. Such additional information about the caller would be valuable to provide to the telephone user. It can be seen that an improved caller ID system for providing geographic identification information about an incoming call to a telephone, cell phone or other communication device is needed.

### SUMMARY OF THE INVENTION

In accordance with the present invention, improved methods, systems and articles of manufacture for providing geographic information regarding an incoming call to a communication device are disclosed. One preferred method of the present invention comprises the steps of receiving an incoming communication from a communication device within a wireless communication system, detecting area code information relating to the incoming communication, determining a geographic location of the incoming communication from the area code information; and communicating the geographic location to a user of the wireless communication device.

All objects, features, and advantages of the present invention will become apparent in the following detailed written description.

### BRIEF DESCRIPTION OF THE DRAWINGS

This invention is described in a preferred embodiment in the following description with reference to the drawings, in which like numbers represent the same or similar elements, as follows:

FIG. 1 depicts a data processing system network in which a preferred embodiment of the present invention may be implemented.

FIG. 2 is an electronic block diagram of a preferred embodiment of the wireless communication device for use within the wireless communication system, as may be utilized in a preferred embodiment of the present invention.

FIG. 3 shows a flow diagram of a process for providing geographic location information of an incoming call, in accordance with the preferred embodiment of the present invention.

### DETAILED DESCRIPTION OF PREFERRED EMBODIMENTS

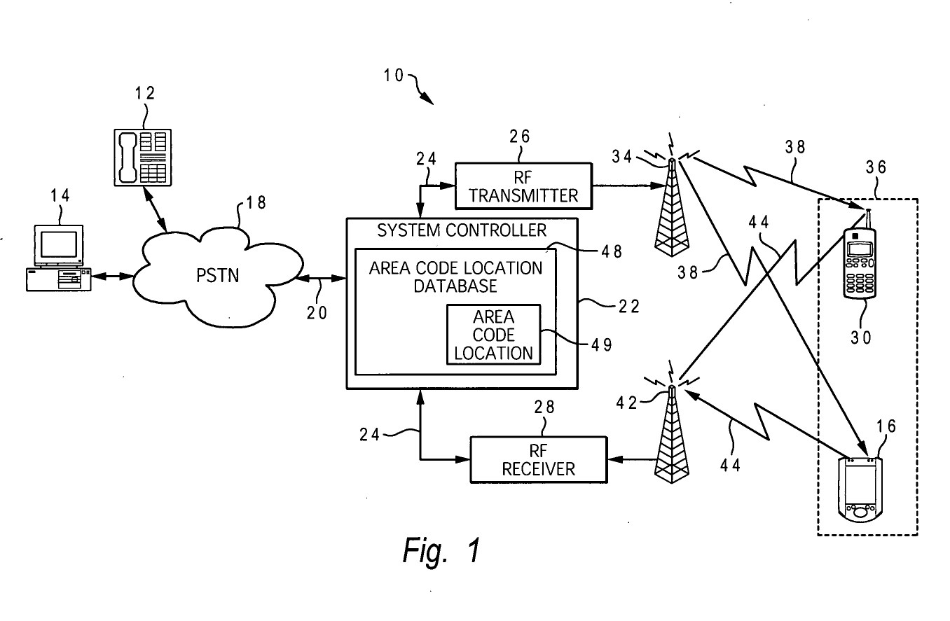

With reference now to the figures, and in particular with reference to FIG. 1, there is shown a block diagram of a wireless communications system in accordance with a preferred embodiment of the present invention. The wireless communication system 10 includes an input device for initiating phone calls or messages into the wireless communication system 10. The input device can be, for example, a telephone 12 or a computer 14 connected through a conventional public switched telephone network (PSTN) 18 and a plurality of telephone links 20 to a system controller 22. The telephone links 20, for example, can be a plurality of twisted wire pairs, a fiber optic cable, or a multiplexed trunk line. A telephone number is typically dialed on the PTSN using the older pulse, loop disconnect or rotary form of dialing, or the more modern Touch-Tone Dual Tone Multi-Frequency (DTMF) dialing method.

The system controller 22 is coupled to and oversees the operation of at least one radio frequency (RF) transmitter 26 and at least one radio frequency (RF) receiver 28 through one or more communication links 24. The communication links 24 typically are twisted pair telephone wires, and additionally can include radio frequency (RF), microwave, or other communication links. The radio frequency transmitter 26 and the radio frequency receiver 28 typically are used with message store and forward stations that encode and decode inbound and outbound messages into formats that are compatible with landline message switched computers and personal radio addressing requirements, such as cellular messages, short messaging service, or paging protocols. The system controller 22 can also function to encode and decode wireless messages that are transmitted to or received by the radio frequency transmitter 26 or the radio frequency receiver 28, for example, from a personal digital assistant (PDA) unit 16. Telephony signals are typically transmitted to and received from the system controller 22 by telephone sets such as the telephone 12 or a wireless communication device 30. The system controller 22 encodes and schedules outbound messages and then transmits the encoded outbound messages through the radio frequency transmitter 26 via a transmit antenna 34 to a plurality of wireless communication devices 36, such as the wireless communication device 30 on at least one outbound radio frequency (RF) channel 38. The downlink message can be, for example, a data message or a voice call. Similarly, the system controller 22 receives and decodes inbound messages such as an uplink message received by the radio frequency receiver 28 via a receive antenna 42 on at least one inbound radio frequency (RF) channel 44 from one of the plurality of wireless communication devices 36. The uplink message can be, for example, a data message, a reply to a data message, a voice call, or a reply to a voice call. In one preferred embodiment of the present invention, area code location database 48 and area code location 49 are also contained within system controller 22.

It will be appreciated by one of ordinary skill in the art that the wireless communication system 10, in accordance with the present invention, can function utilizing any wireless RF channel, for example, a one or two-way pager channel, a mobile cellular telephone channel, or a mobile radio channel. Similarly, it will be appreciated by one of ordinary skill in the art that the wireless communication system 10 can function utilizing other types of communication channels such as infrared channels. In the following description, the term “wireless communication system” refers to any of the wireless communication systems mentioned above or an equivalent.

Similarly, it will be appreciated by one of ordinary skill in the art that the wireless communication device 36 in accordance with the present invention, can be a mobile cellular telephone, a wireless personal digital assistant, a mobile radio data terminal, a mobile cellular telephone having an attached data terminal, or a two way pager, for example. It will be further appreciated that while the preferred embodiment is described within a wireless communication device, the present invention is intended to apply equally to a wired communication device. For example, in one preferred embodiment, wireless communication devices 36 are replaced with telephones 12. In the following description, the term “wireless communication device” refers to any of the devices mentioned above or an equivalent.

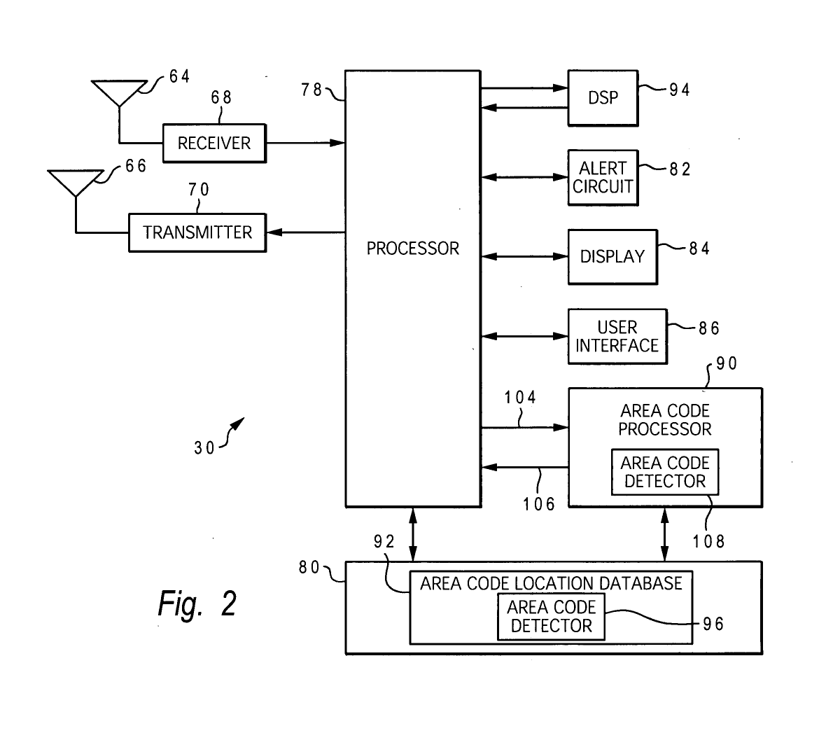

FIG. 2 is electronic block diagram of a preferred embodiment of the wireless communication device 30 for use within the wireless communication system 10. It will be appreciated by one of ordinary skill in the art that the electronic block diagram of FIG. 2 is illustrative of each of the plurality of wireless communication devices 36 assigned for use in the wireless communication system 10. While the preferred embodiment as disclosed is implemented within a cell phone to update an address book therein, it will be appreciated by those skilled in the art that the present invention is applicable to updating of telephone numbers in a variety of wireless communication devices and personal storage devices storing and utilizing telephone numbers. It will also be appreciated that the present invention can be implemented in mobile architectures such as laptops, sub-notebooks, handheld computers such as personal digital assistants and companion devices, and mobile appliances such as smart phones, pagers, simple messaging devices and wearable devices.

Referring to FIG. 2, the wireless communication device 30 includes a first antenna 64, a second antenna 66, a receiver 68, a transmitter 70, a processor 78, a memory 80, a digital signal processor (DSP) 94, an alert circuit 82, a display 84, a user interface 86, and error code processor 90. It will be appreciated by one of ordinary skill in the art that the error code processor 90 can, in the alternative, be a software program or component, a hardware circuit, an integrated part of processor 78, or any other equivalent. To perform the necessary functions of the wireless communication device 30, the processor 78 is coupled to the memory 80, which preferably includes a random access memory (RAM), a read-only memory (ROM), and an electrically erasable programmable read-only memory (EEPROM)(not shown). The memory 80 includes an address book (not shown) containing, for example, individual entries storing home, business and cell phone numbers for an individual or company. The memory 80 also includes an address memory, a message memory, and a location memory (all not shown).

The first antenna 64 intercepts transmitted signals from the wireless communication system 10. The first antenna 64 is coupled to the receiver 68, which employs conventional demodulation techniques for receiving the communication signals transmitted by the wireless communication system 10 of FIG. 1. Coupled to the receiver 68, is the processor 78 utilizing conventional signal-processing techniques for processing received messages. It will be appreciated by one of ordinary skill in the art that additional processors of the same or alternative type can be utilized as required to handle the processing requirements of the processor 78. The processor 78 decodes an address in the demodulated data of the received message, compares the decoded address with one or more addresses stored in an address memory of the memory 80, and when a match is detected, proceeds to process the remaining portion of the received message.

The transmitter 70 is coupled to the processor 78 and is responsive to commands from the processor 78. When the transmitter 70 receives a command from the processor 78, the transmitter 70 sends a signal via the second antenna 66 to the wireless communication system 10. The signal, for example, can be the uplink message or call. In an alternative embodiment (not shown), the wireless communication device 30 includes one antenna performing the functionality of the first antenna 64 and the second antenna 66. Further, the wireless communication device 30 alternatively includes a transceiver circuit performing the functionality of the receiver 68 and the transmitter 70. It will be appreciated by one of ordinary skill in the art that other similar electronic block diagrams of the same or alternate type can be utilized for the wireless communication device 30 to handle the requirements of the wireless communication device 30.

Upon receipt and processing of a message or call, the processor 78 preferably generates a command signal to the alert circuit 82 as a notification that the message or call is being received. The alert circuit 82 can include a speaker (not shown) with associated speaker drive circuitry capable of playing melodies and other audible alerts, a vibrator (not shown) with associated vibrator drive circuitry capable of producing a physical vibration, or one or more LEDs (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 82. The user interface 86 can be one or more buttons used to generate a button press, a series of button presses, stylus input, a voice response from the device user, or some other similar method of manual response initiated by the device user of the wireless communication device 30.

Upon receipt of a message or call, the processor 78 preferably also generates a command signal to the display 84 to generate a yisual notification of the receipt and storage of the message or call. The message or call indication, for example can be the activation of one of a plurality of message or call icons on the display 84. The display 84 can be, for example, a liquid crystal display utilized to display text. It will be appreciated by one of ordinary skill in the art that other similar displays such as dot matrix displays can be utilized for the display 84.

In a preferred embodiment of the present invention, the wireless communication device 30 includes an area code processor 90. The wireless communication device 30 performs area code processing functions within the area code processor 90 using a processor command 104 sent from the processor 78. The area code processor 90 sends a response 106 in reply to the processor command 104. In an alternative preferred embodiment, where wireless communication devices 36 are replaced with another telephone 12, area code processor 90 and area code location database 92 are contained in telephone 12.

When cell phone 30 receives a phone call over a connection from, for example, telephone 12 or computer 14, system controller 22 will generate signals representing the caller identification information of the telephone 12 or computer 14 and transfer those signals to cell phone 30. This caller ID service is typically offered by most local or cellular telephone service providers, and is typically a frequency shift key (FSK) signal transmitted over the telephone connection. Area code processor 90 extracts the area code information from the caller identification information transmitted by system controller 22 and then accesses area code location database 92 within memory 80 to match the extracted area code with an associated entry identifying the geographic location of that area code (hereinafter “area code location 96”). For example, the system controller 22 delivers the calling line number “AAA-XXX-YYYY” as part of the caller ID information to identify the telephone number of the incoming call. Area code processor 90 is programmed to detect the area code, in this example, AAA, based on the telephone number format used locally for telephone systems. The area code AAA is used to index into area code location database 92 to locate the area code location 96 corresponding to the incoming call's area code (i.e., AAA).

In one preferred embodiment, the functionality of area code processor 90 could be implemented automatically to produce a display on display 84 of area code location 96 determined by area code processor 90. The geographic location is displayed automatically for the user of cell phone 30 whenever an incoming call is detected. Alternatively, the user of cell phone 30 could initiate the display of the additional geographic information regarding the area code location by engaging user interface 86 to instruct area code processor 90 to lookup the area code location 96 and display the result on display 84. For example, if cell phone 30 receives an incoming call from a phone number “(512) 555-4259,” area code detector 108 would extract the area code “512” from the incoming call's phone number, and then area code processor 90 would index into area code database 92 to retrieve a corresponding area code location 96 identifying the area code as originating from the geographic location of “Austin, Tex., U.S.A.” Thereafter, area code processor 90 would display a message on display 84 such as “Area Code: Austin” to the cell phone user. In an alternative embodiment, the user may override the message displayed for a user-identifed telephone number. For example, if a known telephone number belongs to a cell phone known to reside at a location other than the one identified with its area code, the user can manually enter the true geographic location for display on display 84 when a phone call is received from that number.

Area code location database 92 can be created or updated by manual or automatic communications between cell phone 30 and system controller 22. On a periodic basis, revisions to the area code location database 92 would be made via the communication link 38 to add new area codes and corresponding geographic locations, and to revise existing area code locations within the database.

With reference back to FIG. 1, an alternative preferred embodiment of the present invention, the area code location database is contained within system controller 22 and not in cell phone 30. In this preferred embodiment, area code location database 48 contains a number of entries indicating the locations of a plurality of area codes. Area code detector 108 determines the area code of the incoming call from the caller identification information transmitted by system controller 22. Upon receiving an incoming call at cell phone 30, area code processor 90 would transmit a control signal 106 that generates a query from processor 78 transmitted by transmitter 70 and antenna 66 to system controller 22 requesting the location of the detected area code in the incoming call. In response, system controller 22 accesses area code location database 48 and indexes into the database to determine the corresponding area code location 49 of the area code indicated in the query. The resulting area code location 49 is then transmitted in a message via RF transmitter 26 and antenna 34 to cell phone 30. Upon receipt of the area code location 49, processor 78 passes the received message over link 104 to area code processor 90. Area code processor 90 then automatically generates a signal to display 84 to generate a visual display or audible representation to the user of the geographic location of the incoming call's area code. In an alternative embodiment, area code processor 90 awaits a user input via user interface 86 to display the caller ID area code geographic location information.

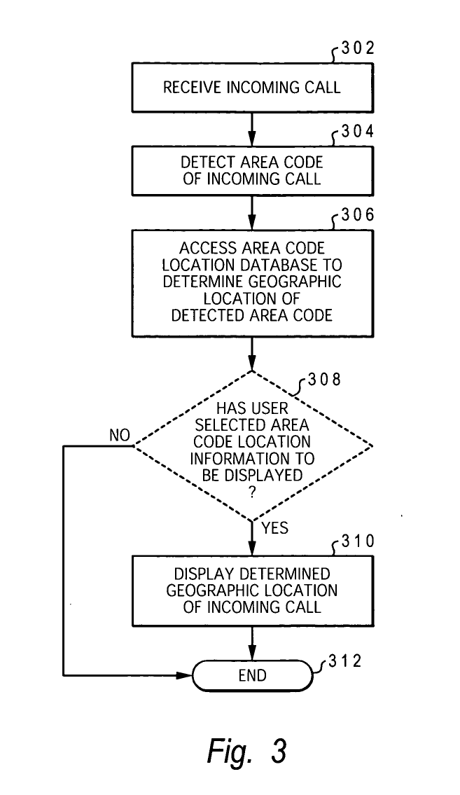

With reference now to FIG. 3, there is shown a flow diagram of a process for determining area code geographic location of an incoming telephone call, in accordance with a preferred embodiment of the present invention. Process 300 begins at step 302, when cell phone 30 receives an incoming call. The process proceeds to step 304, where cell phone 30 detects the area code of the incoming call based on the caller ID information provided by the central station or exchange in PSTN 18 or system controller 22. Thereafter, the process proceeds to step 306 where cell phone 30 accesses an area code database contained within the memory of the cell phone 30 or through a series of commands or signals communicating to system controller 22 and accessing a database 48 therein. The accessed database (92 or 48) is indexed by the detected area code location (96 or 49) of the incoming call to determine a corresponding geographic location of the detected area code for the incoming call. If the area code location database is resident on system controller 22, the determined geographic location is transmitted back to cell phone 30 using commands and signals as is well known by those skilled in the art. The process then proceeds to decision block 308, where area code processor 90 waits to receive a command 104 indicating that the user of cell phone 30 has selected area code geographic location information to be displayed on the cell phone's display 84. If the user has not selected the area code geographic location information, the process ends at step 312. If the user does select the area code location information to be displayed, the process proceeds to step 310, where area code processor 90 instructs processor 78 via command 106 to display the determined geographic location of the incoming call on display 84. Thereafter, the process ends at step 312.

Decision block 308 is shown in dashed lines to indicate that this process step can be eliminated from an alternative preferred embodiment of the present invention where area code processor 90 automatically displays the area code geographic location information upon receipt of the data from databases 92 or 48. In such alternative preferred embodiment, area code processor 90 automatically bypasses step 308 and proceeds to step 310.

While the invention has been particularly shown and described with reference to a preferred embodiment, it will be understood by those skilled in the art that various changes in form and detail may be made therein without departing from the spirit and scope of the invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code for remote execution. The method form of the invention may be practiced by combining one or more machine-readable storage devices containing the code according to the present invention with appropriate standard computer hardware to execute the code contained therein. An apparatus for practicing the invention could be one or more computers and storage systems containing or having network access to computer program(s) coded in accordance with the invention. While this invention is described in terms of the best mode for achieving this invention's objectives, it will be appreciated by those skilled in the art that variations may be accomplished in view of these teachings without deviating from the spirit or scope of the present invention.

What is claimed is:

1. A method in a wireless communication device for determining geographic location information related to an incoming call to the wireless communication device, said method comprising the steps of:
receiving an incoming communication from a communication device within a wireless communication system;
detecting area code information relating to the incoming communication;
determining a geographic location of the incoming communication from the area code information; and
communicating the geographic location to a user of the wireless communication device.

2. The method according to claim 1, wherein the incoming communication is a telephone call.

3. The method according to claim 1, wherein the wireless communication device is a cellular telephone.

4. The method according to claim 1, wherein the step of detecting area code information includes extracting an area code from the caller identification information transmitted to the wireless communication device in conjunction with the incoming communication.

5. The method according to claim 1, wherein the step of determining a geographic location of the incoming communication from the area code information includes accessing a database containing an entry associated with the area code information and retrieving the entry, wherein the entry is the geographic location of the area code information.

6. The method according to claim 5, wherein the database is stored within memory in the wireless communication device.

7. The method according to claim 5, wherein the database is stored within memory in the wireless communication system.

8. The method according to claim 1, wherein the step of communicating the geographic location to a user of the wireless communication device includes displaying the geographic location on a display of the wireless communication device.

9. The method according to claim 1, wherein the step of communicating the geographic location to a user of the wireless communication device includes playing an audible indication of the geographic location from the wireless communication device.

10. A wireless communication device for determining geographic location information related to an incoming call to the wireless communication device comprising:
means for receiving an incoming communication from a communication device within a wireless communication system;
means for detecting area code information relating to the incoming communication;
means for determining a geographic location of the incoming communication from the area code information; and
means for communicating the geographic location to a user of the wireless communication device.

11. The wireless communication device according to claim 10, wherein the incoming communication is a telephone call.

12. The wireless communication device according to claim 10, wherein the wireless communication device is a cellular telephone.

13. The wireless communication device according to claim 10, wherein the means for detecting area code information includes means for extracting an area code from the caller identification information transmitted to the wireless communication device in conjunction with the incoming communication.

14. The wireless communication device according to claim 10, wherein the means for determining a geographic location of the incoming communication from the area code information includes means for accessing a database containing an entry associated with the area code information and retrieving the entry, wherein the entry is the geographic location of the area code information.

15. The wireless communication device according to claim 14, wherein the database is stored within memory in the wireless communication device.

16. The wireless communication device according to claim 14, wherein the database is stored within memory in the wireless communication system.

17. The wireless communication device according to claim 10, wherein the means for communicating the geographic location to a user of the wireless communication device includes means for displaying the geographic location on a display of the wireless communication device.

18. The wireless communication device according to claim 10, wherein the means for communicating the geographic location to a user of the wireless communication device includes means for playing an audible indication of the geographic location from the wireless communication device.

19. An article of manufacture comprising machine-readable medium including program logic embedded therein that causes control circuitry in a wireless communication device for determining geographic location information related to an incoming call to the wireless communication device to perform the steps of:
receiving an incoming communication from a communication device within a wireless communication system;
detecting area code information relating to the incoming communication;
determining a geographic location of the incoming communication from the area code information; and
communicating the geographic location to a user of the wireless communication device.

20. The article of manufacture of claim 19, wherein the incoming communication is a telephone call.

21. The article of manufacture of claim 19, wherein the wireless communication device is a cellular telephone.

22. The article of manufacture of claim 19, wherein the step of detecting area code information includes extracting an area code from the caller identification information transmitted to the wireless communication device in conjunction with the incoming communication.

23. The article of manufacture of claim 19, wherein the step of determining a geographic location of the incoming communication from the area code information includes accessing a database containing an entry associated with the area code information and retrieving the entry, wherein the entry is the geographic location of the area code information.

24. The article of manufacture of claim 23, wherein the database is stored within memory in the wireless communication device.

25. The article of manufacture of claim 23, wherein the database is stored within memory in the wireless communication system.

26. The article of manufacture of claim 19, wherein the step of communicating the geographic location to a user of the wireless communication device includes displaying the geographic location on a display of the wireless communication device.

27. The article of manufacture of claim 19, wherein the step of communicating the geographic location to a user of the wireless communication device includes step of playing an audible indication of the geographic location from the wireless communication device.
